(19) United States
(12) Patent Application Publication
(10) Pub. No.: US 2003/0163694 A1
(43) Pub. Date: Aug. 28, 2003

(54) Method and system to deliver authentication authority web services using non-reusable and non-reversible one-time identity codes

(76) Inventors: Chaing Chen, Ellicott City, MD (US); Ning Chen, Yorba Linda, CA (US)

Correspondence Address: Chaing Chen, 3871 Woodville Lane, Ellicott City, MD, 21042, US

(21) Appl. No.: 10/082,982

(22) Filed: Feb. 25, 2002

(51) Int. Cl. H04L 9/00

(52) U.S. Cl. 713/170

(57) ABSTRACT

According to the invention, a system and a method to use Authentication Authority (AA) Web services to authenticate users using non-reusable and non-reversible one-time identity (OTI) codes are disclosed. Components of this system comprise: Gateway Authority (GA), Authentication Authority (AA), Authentication Client(AC), and Authentication Handler (AH). The function of the GA is to register, manage and delegate authentication services to AA. Furthermore, the GA is also responsible for describing and publishing its AA Web service to the industry's Web Service Registry. The function of the AA is to register, manage and authenticate user's identity. The function of the AC is to generate OTI codes on the client's machine and send these codes to the business application server for authentication. The function of the AH is to enable the business application server to process OTI codes, compose authentication requests, and communicate with the AA to authenticate users.

OTI codes are generated by a set of non-reversible hash and modular math operators. A salient feature of the OTI code is that this code can only be used once. Another important feature of the OTI code is that it contains information of user identities without the risk of exposing these identities when transmitted over the Internet. This feature is the essence of the AA Web service system, which enables the identification and validation of user information in a secure manner.

### FEDERALLY SPONSORED RESEARCH

Not Applicable

### SEQUENCE LISTING OR PROGRAM

Not Applicable

### FIELD OF THE INVENTION

The present invention relates to a method and a system for authenticating the identity of an individual or a business entity, and more specifically, a method and a system for providing identity authentication security using Web service technology and non-reusable and non-reversible one-time identity codes.

### BACKGROUND OF THE INVENTION

The Web service industry has experienced a rapid growth during the past year. This growth trend is expected to continue at a strong pace in the foreseeable future. Addressing the security needs of the Web service industry is very important because the economic future of thousands of individuals and companies is at stake.

The Web service uses client and server model to exchange business information between trading partners over the Internet. To access resources on the business application server, the client is required to present a proof of identity. The current Web service security architecture uses reusable passwords to validate users. As discussed below, the use of this kind of insecure authentication system can pose great security risks, especially when the value of the business information is high.

Not only the Web service industry has a problem to securely validate its client's identity, but also the traditional online business industry has a similar problem. Currently, the majority of web sites uses “username and password” as their main authentication method. The problem with this method is that computer users often use a password that is simple and easy to memorize. To make matter worse, users don't change their password frequently as suggested by security experts. As a result, it is not difficult for a hacker to use a social engineering or brute force method to obtain users' password. Therefore, there is a need for an authentication method that would be better, secure and convenient to use.

In the current market place, RSA's SecureID can generate time-dependent one-time passwords for users to log onto computer systems. This is a good and secure solution for authentication purpose. However, SecureID or a similar authentication system is usually deployed on an organizational Intranet. Only an authorized user from that organization can use this authentication system. If a user would like to access protected resources of five companies that he/she was authorized to do so, he/she has to carry five SecureIDs or authentication devices that were issued by these companies. Obviously, this is neither a distributable nor a desired solution to log onto computers in the Internet environment. In contrast, the desired solution would be that the user carries only one authentication device and register his/her identity with only one authentication authority. He/She can then use codes generated by this device to log onto any computer on the Internet that he/she is authorized to access.

The SecureID's authentication system is not scalable either. When the user base grows, the direct solution is to segment users based on the organization chart and add more authentication servers to serve these users. The problem of this approach is that there is little or no communication among authentication servers. It is not hard to picture that the authentication process can become very complicated in the long run. In some situation, users may also need to carry several authentication devices to access different computer resources, even in the Intranet environment.

To build a scalable and distributable authentication system, the communication between different computer servers is a problem because the Internet environment comprises incompatible platforms, operation systems (OS) and computer languages. To resolve this incompatibility problem, the answer may hinge on the use of the emerging Web service technology. Because the Web service technology uses Hypertext Transport Protocol (HTTP), eXetnsible Markup Language (XML) and Simple Object Access Protocol (SOAP) for computers to communicate with each other, these protocols have a characteristic of being platform, OS and language independent. Thus, the Web service technology can make the task of building such a scalable and distributable authentication authority system possible. The beauty of this invention is to use Web service technology to create an authentication system to resolve Web service's security deficiency.

### SUMMARY

The object of this invention is to describe a system that can deliver scalable and distributable authentication services using Web service technology. This system comprises Gateway Authority (GA), Authentication Authority (AA), Authentication Client (AC) and Authentication Handler (AH). The GA is responsible to register, manage and delegate authentication services to the AA. The GA is also responsible to describe and publish its authentication services to the Web Service industry's Registry. The AA is a subordinate of GA and is responsible to register, manage and authenticate user identity (UID). The AC is the tool that client uses to generate one-time identity (OTI) codes. The client uses these codes to log onto business application servers. The AH is installed on the business application server and is responsible for processing OTI codes, composing authentication requests and communicating with the AA to authenticate users. This system is called an AA Web service system. Using this AA Web service system, the user's authentication session starts from the OTI code generation by AC. This OTI code is passed to AH and used as a part of the authentication request composed by AH. This authentication request is then forwarded to GA and redirected to AA. After UID is validated by AA, the authentication response is sent back to AH. AH notifies the business application server to authorize the user to complete the logon procedure. The request and response messages are transported by HTTP packets. The message body is in a form of XML document. Communications among AH, GA, AC and AA are encrypted using SSL (Secure Socket Layer).

The ability to generate non-reusable and non-reversible codes is an important feature in this AA Web service system. Four pieces of information are used for generating OTI codes. There are: 1.) a unique UID, 2.) a device or AC's (AID), 3.) a non-predictable sequence number, and 4.) a user's private identity. These variables are processed by a set of modular and hash operators to produce OTI codes.

Initially, the non-predictable sequence number is a random number generated by user's authenticator. After the OTI code is generated, the non-predictable sequence number is replaced by an intermediate value generated by the modular operator. To get the authentication process working, user is required to register his/her identities and conduct synchronization with AA. Thus, both AA and AC use the same set of information and algorithm to generate OTI codes independently. If AA finds that the OTI code is the same as that generated by AC, the authentication is successful.

The idea of using AA, AC and OTI codes to authenticate users is not new. However, the idea to separate the role of AA into three distinctive components (GA, AH and AA) is new. The innovation is to use this new idea to develop a scalable and distributable system. As a result, a user can use only a “single” authentication device to log onto any server on the Internet that he/she is authorized to use. The applications of this innovation can be enormous. This system can be used as a system not only to log onto computers, but also to verify individual's identity. Assuming a user would like to buy a computer from ABC Inc. over the phone, the current practice is to give the credit card information to ABC. Since there is no way to validate the user's identity, ABC always has a doubt as to whether there is a fraudulent use of the credit card. However, if an authentication system disclosed in this invention is implemented, the user can use his/her authentication device to generate an OTI code and give it to ABC. ABC then feeds the OTI code to its AH for identity verification. Thus, this additional procedure makes the use of credit cards very safe and secure.

### BRIEF DESCRIPTION OF THE DRAWING

Drawing Figures

FIG. 1 is a schematic diagram showing the architecture of the AA Web service system and its components.

FIG. 2 is a schematic diagram showing AA Web Service Functional Architecture and its components.

### REFERENCE NUMERALS IN DRAWINGS

10 The Internet

20 Web Service Registry (WSR)

21 Gateway Authority (GA)

22 Authentication Authority (AA)

23 Authentication Client (AC)

24 Authentication Handler (AH)

25 Human interface

26 Other GA (OGA)

30 Registration

31 Synchronization

32 Confirmation

33 Code Verification

34 Sync Code Generation

35 OTI Code Generation

36 AA Web service Publishing

37 AA Web service Discovering

38 Registration

39 Logon

40 Identity Verification

41 Business Application Server (BAS)

### DETAILED DESCRIPTION

In the following, the detailed description is divided into two sections. To simply illustrate what is involved in the AA Web service system, architecture of the system is described in the first section. To further illustrate how the AA Web service system works, architecture of its functionality and the associated algorithm are described in the second section.

AA Web Service System Architecture and its Components

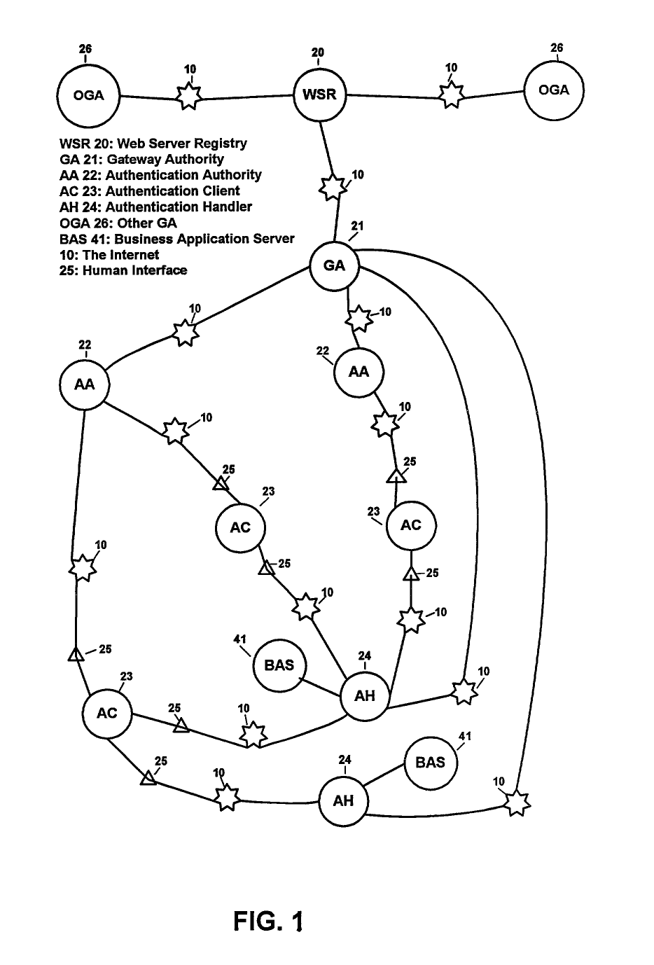

FIG. 1 depicts the AA Web service architecture. There are four components in this system: GA 21, AA 22, AH 24 and AC 23. These components are connected via the Internet 10. They communicate with each other by sending and receiving HTTP packets over SSL. The AA Web service request and response messages are delivered using SOAP standard. In addition, the architecture shown in FIG. 1 can also apply to a communication method using File Transport Protocol (FTP) and Simple Mail Transport Protocol (SMTP).

In FIG. 1, the GA 21, the gateway for accessing the AA Web service, has many subordinate AAs 22 connected to it. The AA 22, the powerhouse to authenticate users, has a group of ACs 23 registered under it. The AC 23, the user authentication device to generate OTI codes, has communication interfaces both with AA 22 and AHs 24. For AC 23 to communicate with AA 22 and AH 24, the use of a human interface 25 method is required if AC is installed on a hand-held device. Finally, the AH 24, the doorkeeper to protect computer's business resources, has an interface to loop back to GA 21.

From the architecture map in FIG. 1, it is noted that having GA 21 as the gateway to redirect authentication service request to its subordinate AAs 22 is the reason why the AA Web service system is scalable. When user base grows, the adding of more AAs 22 will not create problem. GA 21 can provide an effective means to manage AAs 22 because of the use of a hierarchical structure.

It is also noted that the user employs only one AC 23 to deal with multiple AHs 24 for identity verification. It means that the user only needs to carry one authentication device and generate OTI codes to log onto any computer in the Internet that he/she is authorized to use. This arrangement is the key, which makes the AA Web service system distributable.

To make this AA Web service system even more scalable and distributable, additional components are added. For example, the Web Service Registry (WSR) 20 is included in the architecture map (FIG. 1) for GA 21 to use the Web Services Description Language (WSDL) to publish its AA Web service. By doing so, GA 21 can use the Universal Description, Discovery and Integration (UDDI) standard to discover the AA Web service published by OGA 26.

In the followings, we summarize AA Web service components and their functionality.

1. Gateway Authority (GA 21): The GA 21 is the gateway for AHs 24 to access authentication services provided by AAs 22. It receives authentication requests from AH 24 and redirects requests to its subordinate AA 22. GA 21 is also responsible to use WSDL to describe and publish its AA Web service to the Web Service Registry 20, and use UDDI to discover AA Web services provided by OGA 26.

2. Authentication Authority (AA 22): The AA 22 is used as an authentication powerhouse. The main responsibility of AA 22 is to authenticate its registered user. The algorithm to drive the engine is described later. Using this algorithm, UID can be authenticated and validated without comprising secure information over the Internet. AA 22 has other functions such as registering users and managing their information. Before the authentication service can be used by the user, the user needs to synchronize his/her AC 23 with AA 22.

3. Authentication Client (AC 23): AC 23 is the authentication device used by the user. The main function of AC 23 is to generate OTI codes. Because the algorithm uses a non-reversible function, the retrieval of the original UID from the resulting OTI code is impossible. AC 23 can be in a form of software or hardware token. The software to drive AC 23 can be downloaded and installed on PDAs, cell phones or other hand-held devices.

4. Authentication Handler (AH 24): The AH 24 is a doorkeeper to protect resources in the Business Application Server (BAS) 41 of a business entity with whom the user has a business relationship. The main function of AH 24 is to receive user's OTI codes as a part of the logon information and forward this information to AA 22. If AA 22 is located in the same Intranet environment as that of AH 24, the logon information will be forwarded to AA 22 directly. Otherwise the logon information will then be forwarded to GA 21. Once AA 22 authenticates the user, AH 24 prompts the BAS 41 allowing the user to access the server's protected resources.

To show how the AA Web service system works, a fictitious scenario is used and described in the followings.

1. Assuming ABC Inc. decides to buy shrimp from Acme Shrimp Co., the first step is to compose a purchase order (PO). In this PO, an OTI code generated by AC 23 is included. This PO is then submitted to Acme's BAS 41. During this stage, ABC uses TCP/IP over the Internet to communicate with Acme's BAS 41 by using HTTP request/response messages that follows the SOAP standard.

2. After receiving the PO, the OTI code is extracted by AH 24 installed on Acme's BAS 41. Subsequently, an authentication request, which contains the information of the OTI code, is composed by Acme's AH 24 and submitted to GA 21.

3. Since GA 21 is the gateway for authentication services, it redirects AH's 24 authentication request to its subordinate AA 22. AA 22 then checks ABC's identity. If AA 22 determines that ABC is a legitimate user, a response message is composed to indicate that ABC is a valid user. Furthermore, a digest (hashed message) of ABC's private identity and ABC's public identity are included in this response message. This response message is then returned to Acme's AH 24. Subsequently, AH 24 checks the response message and verifies ABC's identity. If everything is fine, AH 24 notifies Acme's BAS 41 and authorizes the acceptance of ABC's PO.

4. Before ABC can begin to submit the PO to Acme, ABC is required to register its UID, AID, public and private identities with AA 22 and download a tool (AC 23) which can generate OTI codes. In addition, ABC also needs to register its public identity and the digest of its private identity with Acme for the identity verification purpose. Meanwhile, Acme is required to subscribe to the authentication service with GA 21 and download a tool (AH 24) which processes authentication requests and responses.

AA Web Service Functional Architecture and Algorithm

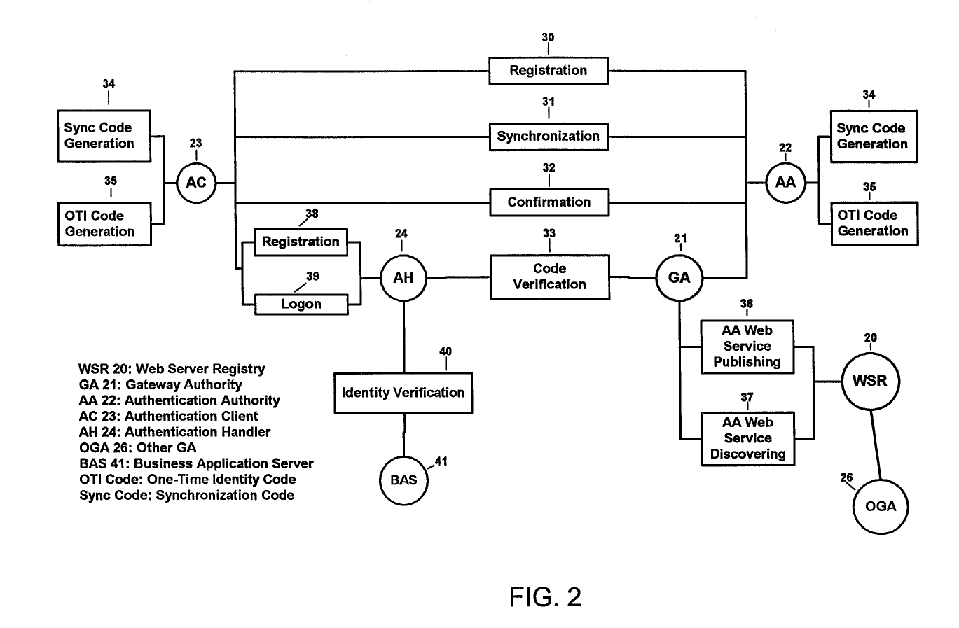

FIG. 2 shows the functional architecture of the AA Web service system and its components. In the following, the description of the functionality will be focused on processes that are occurred between AC 23 and AA 22. Ten functions are described. They are: Registration 30, Sync Code Generation 34, Synchronization 31, Confirmation 32, OTI Code Generation 35, Code Verification 33, Identity Verification 40, Logon 39, AA Web Service Publishing 36, and AA Web Service Discovering 37.

1. Registration 30:

The Registration 30 function is to provide a secure communication channel for a user to use AC 23 to register his/her UID, AID, public and private identities with AA 22. The private identity comprises user's biometric identity and other shared secret information.

The user is also required to register his/her public identity and the digest of the private identity with AH 24.

2. Sync Code Generation 34:

The Sync Code Generation 34 function is to generate Sync Codes by AC 23 and AA 22 independently. The mechanism is to “seed” AC 23 and AA 22 with the same information that can lead to the generation of an identical non-predictable sequence number on AC 23 and AA 22. Ideally, the user will only need to synchronize AC 23 with AA 22 once when the user completes the Registration 30 function with AA 22. However, the user can conduct resynchronization whenever there is a concern that the computer security might be compromised.

The first step of the Sync Code Generation 34 function is to generate a random number by AC 23 and AA 22. This random number generator is seeded by using the same information that is a function of UID, AID and private identity. Subsequently, this random number is processed by a modular operator. A subset of the result is used as the Sync Code. AC 23 then forwards this Sync Code to AA 22 for synchronization.

The mathematical representation of this step is described as the following.

YA=g\hat{ }XA mod p, (Equation 1)

where g is a 128 byte base modulus, p is a 128 byte common modulus, XA is a 128 byte random number seeded by the UID, AID and private identity. The symbols “\hat{ }” denotes a power operator and “mod” denotes a modular operator.

The variable YA is then hashed as:

SC=hash(YA). (Equation 2)

Subsequently, SC is encoded by a base64 encoder. The resulting Sync Code is the first 6 characters of the encoded string, i.e.,

Sync Code=base64(SC).substring(0,6), (Equation 3)

where base64 denotes a base64 encoder while ‘substring’ is a string operator.

3. Synchronization 31:

After the Sync Code is generated by AC 23 and sent to AA 22. The next step is to conduct Synchronization 31. The detail is given in the following.

After receiving the Sync Code, AA 22 also uses Equations 1-3 to compute an identical Sync Code independently as described before. If the Sync Code generated by AA 22 is the same as that from AC 23, AA 22 then uses the following equation for synchronization:

KB=YA\hat{ }XB mod p, (Equation 4)

where the value of YA is from Equation 1 and value of XB is derived from UID, AID and private identity. The variable KB is the used as the non-predictable sequence number and saved for future use.

Meanwhile, AC 23 also executes Equation 4 and saves KB as the non-predictable sequence number as well. At this point, AC 23 and AA 22 are synchronized, because they have the same set of information about the UID, AID, non-predictable sequence number and private identity. They can use the information for future authentication sessions.

It is noted that the Sync Code is a subset of YA. It is simply used as a reference pointer to ensure that AA 22 and AC 23 are using the same algorithm and data for synchronization.

4. Confirmation 32:

The purpose of the Confirmation 32 function is to enable user to have a way to ensure that the synchronization between AC 23 and AA 22 is successful. The following is the algorithm to generate the Confirmation Code:

CC=hash(KB), (Equation 5)

where CC is the resulting Confirmation Code and KB is the non-predictable sequence number derived from Equation 4.

To generate Confirmation Code, CC is encoded by a base64 encoder. The Confirmation Code is represented by the first six characters of the resulting encoded string, i.e.,

Confirmation Code=base64(CC).substring(0,6). (Equation 6)

5. OTI Code Generation 35:

The function of the OTI Code Generation 35 is to generate OTI codes. The computation begins with the use of the non-predictable sequence number that was derived and saved from Equation 4. This non predictable sequence number together with UID, AID and private identity are further processed by a non-reversible operator, i.e.,

YB=g\hat{ }XB mod p, (Equation 7)

where g is the base modulus and p is the common modulus. The variable XB is defined as:

XB=UID+AID+non-predictable sequence number+private identity. (Equation 8)

The next step is to hash YB to produce a variable PS, i.e.,

PS=hash(YB). (Equation 9)

The OTI code is the first eight characters representation of the resulting base64 encoded string of PS.

OTI code=base64(PS).substring(0,8). (Equation 10)

After the OTI code is generated, the variable YB is renamed as the non-predictable sequence number and saved for future OTI Code Generation 35 session, i.e.,

non-predictable sequence number=YB. (Equation 11)

OTI codes for future session are generated by repeating Equations 7-11. The generating of YB and updating of the non-predictable sequence number is the reason why the algorithm can produce non-repetitive codes.

6. Code Verification 33:

The Code Validation 33 function is used to verify user's identity. AA 22 uses the same set of equations (Equations 7-11) to produce an OTI code independently. If the OTI code generated by AA 22 is the same as that by AC 23, the validation is successful.

Obviously, to generate the same OTI code, AA 22 must have the same set of user information as that used by AC 23. The Registration 30 and Synchronization 31 functions can guarantee that AC 23 and AA 22 have a common ground to begin an authentication session. After the starting of a new authentication session, an identical non-predictable sequence number will be generated and updated by AA 22 and AC 23, respectively. Because of this identicalness, AC 23 and AA 22 have a common ground again for another authentication session. This cycle of generating and validating OTI codes can be repeated indefinitely without another synchronization.

7. Identity Verification 40:

After the OTI code is verified by AA 22, an authentication response message is composed by AA 22 and transmitted back to AH 24. This message comprises the authentication status, the user public identity, and the digest of the user private identity. After receiving the message, AH 24 checks the status. If the authentication is valid, AH 24 then checks its database for the user public identity and the digest of the private identity. If everything matches, AH 24 grants permission for the user to log onto BAS 41.

8. Logon 39:

The Logon 39 function is to provide an interface for AC 23 to transmit OTI codes to AH 24. After receiving the OTI code, AH 24 composes an authentication request and submits the request to GA 21 as a part of the Code Verification 33 function.

9. AA Web Service Publishing 36:

The AA Web Service Publishing 36 function is to publish the authentication service information to Web Service Registry 20. The purpose is to let OGA 26 to be able to use the service offered by GA 21.

10. AA Web Service Discovering 37:

The AA Web Service Discovering 37 function is to discover authentication services offered by OGA 26. By including AA Web Service Publishing 36 and AA Web Service Discovering 37 functionality in FIG. 2, the AA Web service system disclosed in the Invention becomes even more scalable and distributable.

What is claimed is:

1. A method and system to deliver authentication authority Web services using non-reusable and non-reversible one-time identity codes, comprising:
(a) authentication authority means to serve as a powerhouse to authenticate user identity,
(b) gateway authority means to serve as a gateway to delegate said authentication authority Web services to said authentication authority means,
(c) authentication client means to serve as an end-user device to generate said one-time identity codes,
(d) authentication handler means to serve as a doorkeeper to protect resources of business entities using said authentication authority Web services,
(e) means comprising:
i. transmitting said one-time identity codes from said authentication client means to said authentication handler means,
ii. composing authentication requests by said authentication handler means, and transmitting said authentication requests from said authentication handler means to means selected from the group consisting of said gateway authority means and said authentication authority means.
iii. processing said authentication requests by said gateway authority means, and redirecting said authentication requests from said gateway authority means to said authentication authority means,
iv. generating authentication responses by said authentication authority means, and transmitting said authentication responses back to said authentication handler means,
whereby a scalable and distributable system to authenticate and validate said user identity will be provided,
whereby a user can use only a single said end-user device to generate said one-time identity codes to identify him/herself and to access protected resources of multiple said business entities,
whereby the authentication system can be used as an ID verification system for said business entities to verify said user identity over a channel selected from the group consisting of the Internet, phone and other communication means.

2. The method and system of claim 1 wherein said gateway authority means contain means to interact with other entities of said gateway authority means, and publish said authentication authority Web services to Web service industry's registries.

3. The method and system of claim 2 wherein said gateway authority means are arranged to use Web Services Description Language (WSDL) to publish said authentication authority Web services, and use Universal Description, Discovery and Integration (UDDI) standard to discover said authentication authority Web services published by other said gateway authority entities.

4. The method and system of claim 1 wherein said gateway authority means, said authentication authority means, said authentication handler means, and said authentication client means are arranged to use Simple Object Access Protocol (SOAP) to communicate, and use Hypertext Transport Protocol (HTTP) packets to transmit data over Secure Socket Layer (SSL).

5. The method and system of claim 4 wherein said data contains means to be transmitted by using File Transport Protocol (FTP) and Simple Mail Transport Protocol (SMTP).

6. The method and system of claim 1 wherein said gateway authority means and said authentication authority means contain means to be separated and placed in the Internet accessible environment to become said scalable and distributable system.

7. The method and system of claim 1 wherein said authentication authority means contain means to register and manage said user identity, said authentication client means identity, said user private identity, and associated vital information.

8. The method and system of claim 1 wherein said authentication authority means contain means for independently generating said one-time identity codes to authenticate said user identity.

9. The method and system of claim 1 wherein said authentication authority means contain means to use platforms which are vendor independent.

10. The method and system of claim 1 wherein said authentication responses generated by said authentication authority means contain means to inform said authentication handler said user identity.

11. The method and system of claim 1 wherein said authentication authority means and said authentication client means contain means to generate synchronization codes and conduct synchronization.

12. The method and system of claim 11 wherein said synchronization codes are arranged to be generated by math functions comprising hash, power and modular math operators, wherein said math functions are arranged to use said user identity, said authentication client identity, and said user private identity as the input information.

13. The method and system of claim 12 wherein said synchronization codes are arranged to contain limited information about said user identity, said authentication client identity, and said user private identity.

14. The method and system of claim 11 wherein said authentication authority means and said authentication client means contain means to generate confirmation codes to verify the success of said synchronization.

15. The method and system of claim 1 wherein said authentication authority means and said authentication client means contain means to independently generate non-predictable sequence number which is an essential part for producing said one-time identity codes.

16. The method and system of claim 15 wherein said non-predictable sequence number is arranged to be generated by math functions comprising hash, power and modular math operators, wherein said math functions are arranged to use said user identity, said authentication client identity, and said user private identity as the input information.

17. The method and system of claims 7, 12, 13 and 16 wherein said user private identity comprises said user's biometric identity and other shared secret information.

18. The method and system of claim 1 wherein said authentication client means contain means to be incorporated in a portable, hand-held device.

19. The method and system of claim 1 wherein said authentication handler means is arranged to be executed on said business entities' computers.

20. The method and system of claim 1 wherein said authentication handler means contain means to receive and process said user logon request, compose and submit authentication request to said authentication authority means, process and validate returned authentication response from said authentication authority means, and grant permission for said user to log onto said business entities' computer.
